(19) United States
(12) Patent Application Publication
(10) Pub. No.: US 2013/0321359 A1
(43) Pub. Date: Dec. 5, 2013

(54) STYLUS WITH PRESSURE SENSOR

(71) Applicant: Adonit Co., Ltd., Taipei (TW)

(72) Inventors: Zachary Joseph Zeliff, Taipei (TW); Yueh-Hua Li, Hsinchu County (TW); Kris Perpich, Austin, TX (US); Yu-Tzu Huang, Taipei (TW); Kai-Yi Lu, Taipei (TW)

(21) Appl. No.: 13/909,479

(22) Filed: Jun. 4, 2013

Related U.S. Application Data
(60) Provisional application No. 61/655,374, filed on Jun. 4, 2012.

(51) Int. Cl. G06F 3/0354

(52) U.S. Cl. CPC G06F 3/03545
USPC 345/179

(57) ABSTRACT

A pressure-sensitive stylus includes a tip operationally coupled to a pressure sensor, where the tip is constrained to depress longitudinally, and the tip is mechanically coupled to a first spring. The tip engages a second spring when depressed longitudinally by a force of a first magnitude.

### CROSS-REFERENCE TO RELATED PATENT APPLICATION

This application claims priority to and the benefit of, pursuant to 35 U.S.C. §119(e), U.S. provisional patent application Ser. No. 61/655,374, filed Jun. 4, 2012, entitled “Stylus With Pressure Sensor,” by Zachary Joseph Zeliff et al., which is incorporated herein in its entirety by reference.

### FIELD OF THE INVENTION

The invention relates generally to stylus design, and more specifically to a stylus with pressure sensor for simulating an ordinary pen.

### BACKGROUND OF THE INVENTION

Styluses are known in the field of controlling touch screen-equipped devices. Such electronic devices may include touch screen-equipped devices, smart phones, personal digital assistances . . . etc. Position detection of the stylus provides input to a computing device associated with the touch screen-equipped devices and is interpreted as user commands. Position detection is performed while the stylus tip is either contacting and/or in proximity with a detection surface of the touch screen-equipped devices. Often, the touch screen-equipped device is integrated with a display screen and a position of the stylus over the screen is correlated with virtual information portrayed on the display screen.

Conventionally, position detection may be implemented by applying capacitive sensors to the touch screen-equipped devices. When a stylus contacts and/or in proximity with the surface of the touch screen-equipped device, the stylus may trigger changes in the electric potentials of the capacitive sensors. Thus, the position of the stylus may be determined. However, when writing, a user often applies different pressure to a pen to present different types of stroke. For example, a higher pressure applied to a pen represents a broader stroke. Generally, conventional styluses with capacitive sensors cannot detect the pressure exerted by a user of the stylus, i.e., the pressure sustained by the tip of the stylus. That is, conventional styluses may not reflect a broader stroke when a higher pressure is applied to the stylus. As a result, there is a need for a stylus with pressure sensor that may detect the sustained pressure change of the stylus and provide a user a writing experience substantially similar to an ordinary pen.

### SUMMARY OF THE INVENTION

In one aspect of the invention, a pressure-sensitive stylus includes a tip operationally coupled to a pressure sensor. In one embodiment, the tip is constrained to depress longitudinally. In one embodiment, the tip is mechanically coupled to a first spring. In one embodiment, the tip engages a second spring when depressed longitudinally by a force of a first magnitude.

These and other aspects of the present invention will become apparent from the following description of the preferred embodiment taken in conjunction with the following drawings, although variations and modifications therein may be effected without departing from the spirit and scope of the novel concepts of the invention.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 showing an exemplary block diagram of a stylus with pressure sensors in accordance with one embodiment of the present invention.

FIGS. 2A and 2B are two schematic views of the stylus according to one embodiment of the present invention.

FIG. 2C shows a force-displacement relationship between the contact pressure and the axial displacement of the stylus according to one embodiment of the present invention.

FIGS. 3A and 3B are two schematic views of the stylus according to another embodiment of the present invention.

FIGS. 3C and 3D respectively show a force-displacement relationship between the contact pressure and the axial displacement of the stylus according to one embodiment of the present invention.

FIGS. 4A-4D are schematic views of the pressure sensor and the pin of a stylus according to embodiments of the present invention.

FIGS. 5A-5D shows different waveforms representing the frequency and the amplitude of the signal generated and transmitted by a communication module according to embodiments of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this invention will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present invention, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

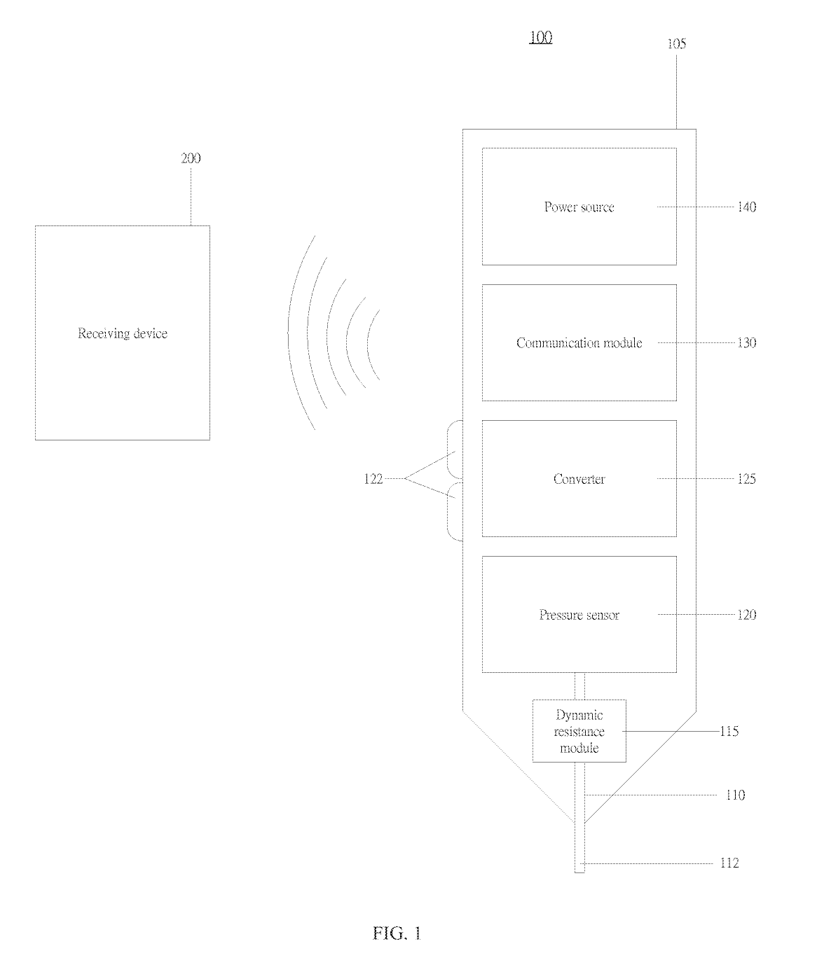

The description will be made as to the embodiments of the present invention in conjunction with the accompanying drawings in FIGS. 1-5. In accordance with the purposes of this invention, as embodied and broadly described herein, this invention, in one aspect, relates to a pressure-sensitive stylus.

Reference is now made to FIG. 1 showing an exemplary block diagram of a stylus with pressure sensor in accordance with one embodiment of the present invention. As illustrated in FIG. 1, a stylus 100 includes a housing 105 and a movable pin 110 partially enclosed within the housing 105. A second end 112 of the pin 110 partially protrudes from one end of the housing. Further, a dynamic resistance module 115 mechanically interacts with the pin 110 and provides resistance when the pin recedes into the housing 105. Typically, the pin 110 recedes into the housing 105 in axial direction in response to a contact pressure applied by a user operating the stylus 100. An exemplary operation of the stylus 100 is by pressing the second end 112 against a surface. Consequently, the pin 110 is released when the contact pressure ceases to be applied, e.g., a non-contacting state or a non-operational state of the stylus 100.

Moreover, a pressure sensor 120, a converter 125, a communication module 130 and a power source 140 are enclosed within the housing 105, each being communicative with one another. According to some embodiments of the present invention, the pressure sensor 120 is operable to detect an axial positioning (or displacement from a neutral state) of the pin 110 or other element contacting the pin 110, and to output a signal according to the axial positioning.

In addition, one or more switches 122 are configured at the outer surface of the housing 105 to allow users to change between different operational modes of the stylus 100, the one or more switches 122 being communicative with the element(s) within the housing 105. Furthermore, a receiving device 200 is electronically communicated with the stylus 100, more specifically, with the communication module 130. Generally, the communication module 130 generates an encoded signal based on an output from the pressure sensor 120 and transmits such signal to the receiving device 200. The communication between the communication module 130 and the receiving device 200 may be wired or wireless. The receiving device may be coupled with an electronic device, which possesses the capability of decoding and processing the received signal.

Particularly, according to some embodiments of the present invention, the communication module 130 may produce a pulsed oscillating signal. The communication module 130 may include and/or may be in communication with an oscillator to produce an AC signal. In some exemplary embodiments, encoding is in the form of acoustic waveform (FM of a pulsed signal) and/or digital information (FSK, PSK and/or ASK.) In the embodiment implementing the acoustic waveform, maintaining a waveform mode of communication allows for an efficient form of high resolution data in parallel with amplitude modulation for additional control. Alternatively, analog encoding may be used for encoding signal based on an output from the pressure sensor 120. That is, analog encoding may be used to associate each output with a pre-defined frequency, whereas each frequency may stand for a different mode. Exemplary modes may include an eraser mode, a mouse right-click mode or a battery health mode. In some exemplary embodiments, a signal generator may not be included in the stylus 100 and the encoding is provided by a Voltage Control Oscillator (VCO) that modulates a frequency of a voltage output of pressure sensor 120. (Not shown.)

According to some embodiments of the present invention, the stylus 100 is powered by the power source 140. Typically, the power source 140 includes one or more batteries. Rechargeable batteries may be used. In addition, the stylus 100 includes a voltage stabilizer (not illustrated) to stabilize a voltage from the power source 140. In some exemplary embodiments, the power source 140 includes an energy pick-up circuit which supplies energy to the stylus 100 from an external signal. For example, a signal supplied by a touch screen-equipped device.

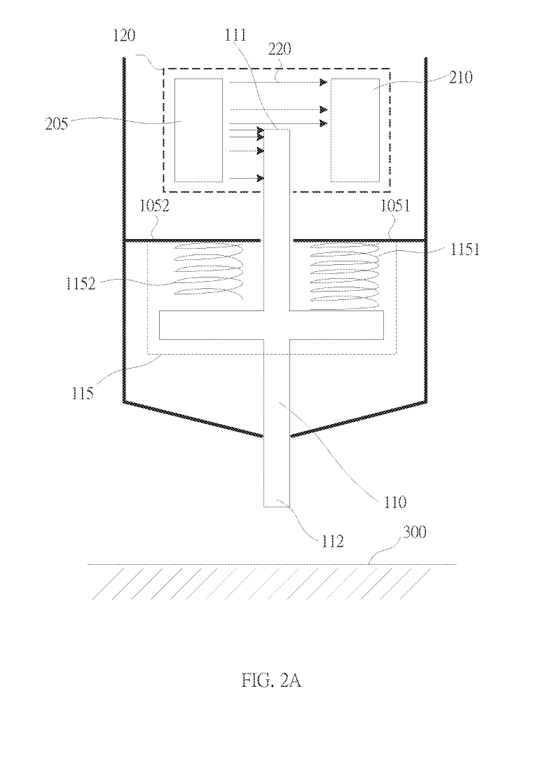

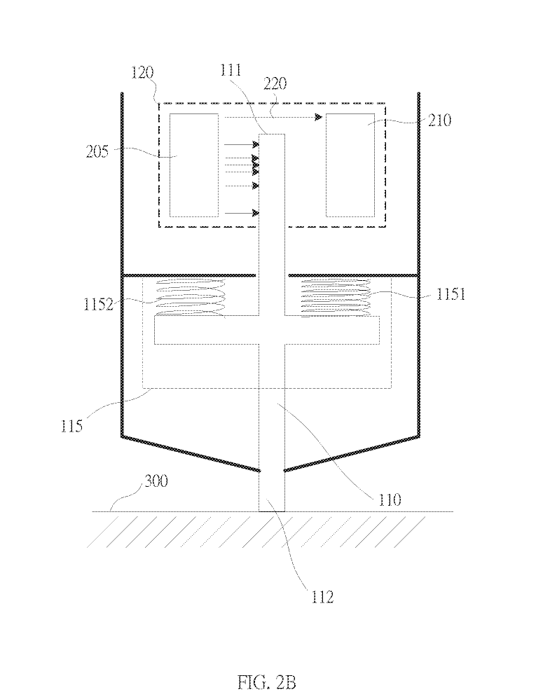

FIGS. 2A-2C are perspective views of the stylus according to some embodiments of the present invention. Specifically, the pin 110, the dynamic resistance module 115 and the pressure sensor 120 are provided in detail. As illustrated in FIG. 2A, the pin 110 comprises a horizontal branch in addition to the vertical branch. A first end 111 of the vertical branch protrudes into the pressure sensor, and a second end 112 of the vertical branch protrudes out of the housing 105. The horizontal branch of the pin 110 serves to prevent the pin 110 from falling out of the housing 105. In addition, between the pressure sensor 120 and the dynamic resistance module 115, horizontal walls 1051 and 1052 are provided as bases for springs 1151 and 1152. The springs 1151 and 1152 provide cushion to the pin 110 when the second end 112 is pressed against a surface 300, thus reducing the axial displacement of the pin 110 in response to variable forces applied on the second end 112 so that a “stiff” pen feeling is achieved which users find similar with using an ordinary pen

Moreover, the pressure sensor 120 comprises an emitter 205 and a detector 210, whereas the emitter 205 emits light in the direction of the light rays 220, and the detector 210 detects the intensity of the light and correspondingly generates a signal. In the present invention, when the pin 110 sustains substantially zero pressure, a portion of the first end 111 is already protruding into the pressure sensor 120 through an opening, thus blocking a portion of the light emitted from the emitter 205, as illustrated in FIG. 2A. In one embodiment, the pin 110 blocks about half of the light emitted from the emitter when the pin 110 sustains substantially zero pressure. When the second end 112 is pressed against a surface 300 thus creating an axial displacement of the pin 110, the first end 111 may protrude even further into the pressure sensor 120, blocking even more light emitted from the emitter 205, as illustrated in FIG. 2B.

According to the present embodiment, during the axial displacement of the pin 110, the pin 110 makes contact with at least one of the springs 1151 and 1152 of the dynamic resistance module 115. Therefore, when the pin 110 sustains a force from zero to no larger than A gram-force, the pin 110 only makes contact with the spring 1151, and when the force exceeds A gram-force, the pin 110 makes contact with both the springs 1151 and 1152. The properties and positions of the springs 1151 and 1152 are configured to obtain a force-displacement relationship between the contact pressure and the axial displacement, as illustrated in FIG. 2C. In this example, when the force sustained by the pin 110 is increased from zero to F1, the displacement of the pin 110 correspondingly increases from zero to d1, showing a force-displacement relationship of slope S1. When the force sustained by the pin 110 is increased from F1 to F2, the displacement of the pin 110 correspondingly increases from d1 to d2, showing a force-displacement relationship of slope S2. Accordingly, the present invention provides increased accuracy in detecting contact pressure, i.e., force sustained by the pin 110, as compared to conventional styluses, and thus provides a user a writing experience substantially similar to an ordinary pen. In addition, the increased accuracy enables the stylus to determine pressure, lack of pressure and/or a change in pressure exerted on the second end 112 of the pin 110 with only a slight axial displacement of the pin 110.

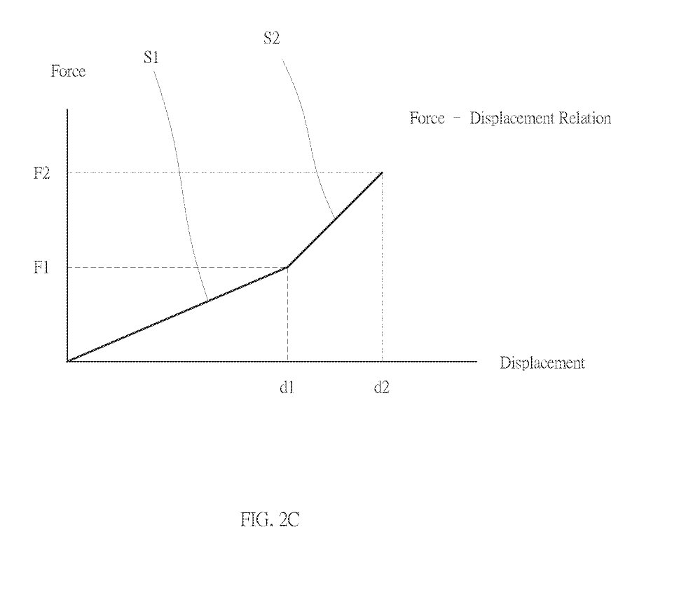

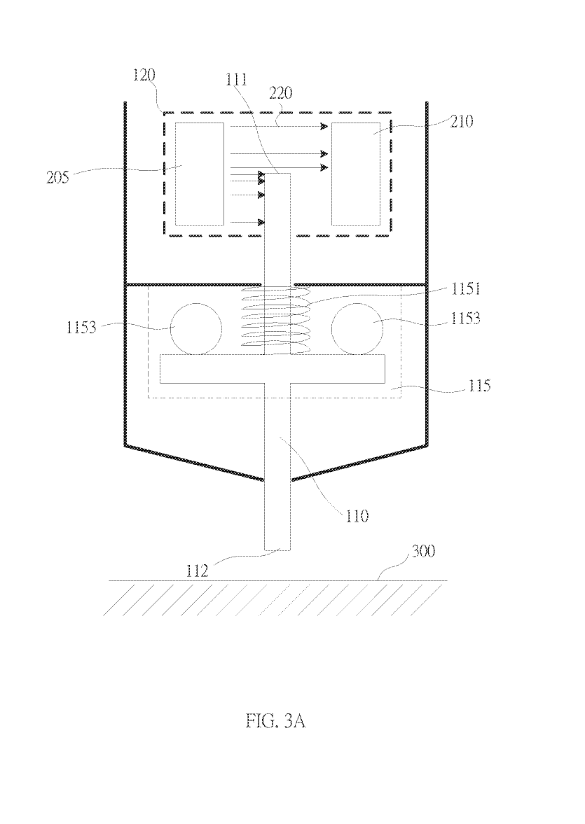

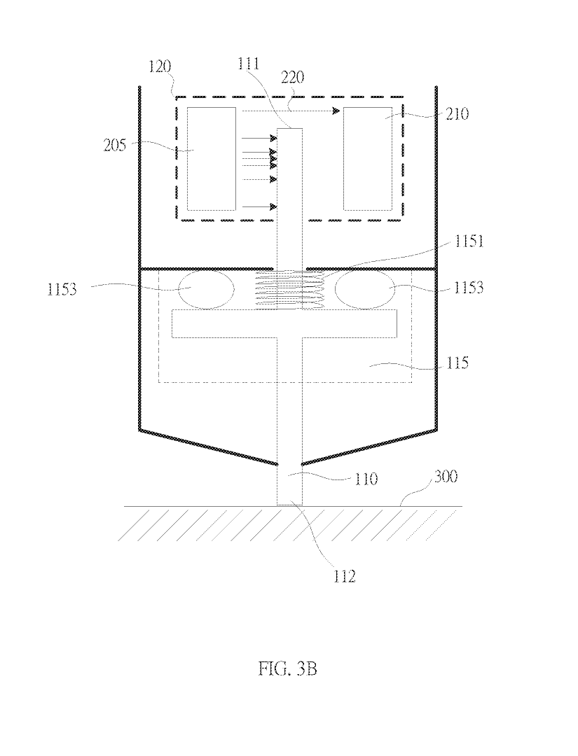

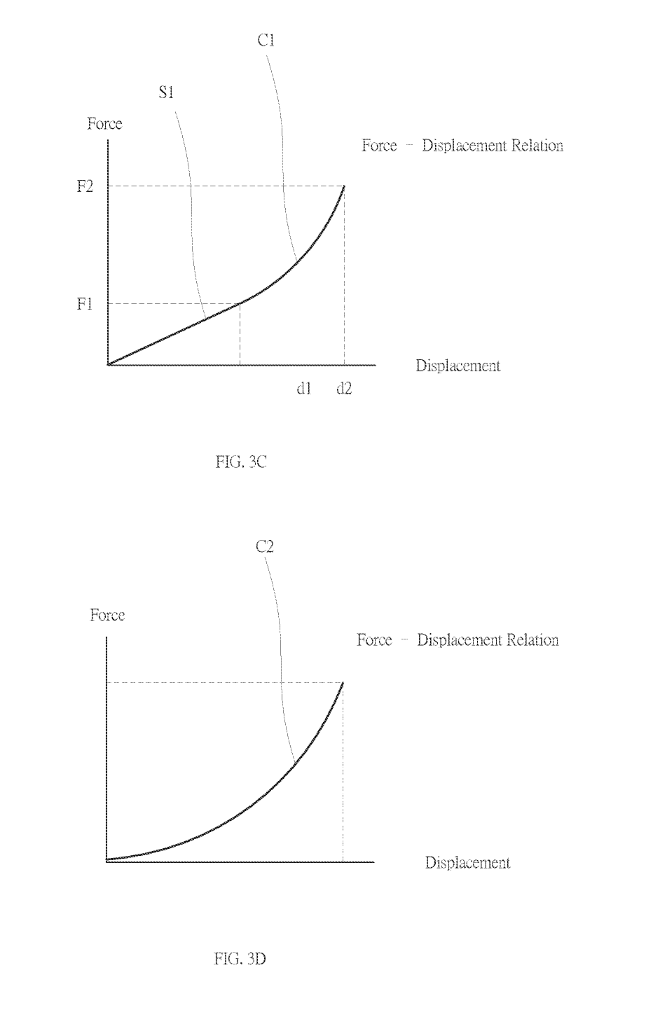

FIGS. 3A-3D are perspective views of the stylus according to some embodiments of the present invention. In this embodiment, the spring 1151 is configured to be surrounding part of the vertical branch of the pin 110, as illustrated in FIG. 3A. Further, the spring 1152 of the dynamic resistance module 115 is replaced by a plurality of elastic components. The elastic components may be round (elastic balls 1153) or of other geometric shape. The elastic balls 1153 is disposed on the horizontal branches of the pin 110, as illustrated in FIG. 3A. Gaps may be left between the plurality of elastic balls 1153 and the horizontal walls 1051 and/or 1052, but the present invention is not so limited. In yet another embodiment, the elastic balls 1153 are replaced by an O-ring surrounding the spring 1151. (Not shown.)

Similar to the aforementioned embodiments, in FIGS. 3A-3C, during an axial displacement of the pin 110, the pin 110 makes contact with at least one of the spring 1151 and the plurality of elastic balls 1153 of the dynamic resistance module 115. Therefore, when the pin 110 sustains a force from zero to no larger than A gram-force, the pin 110 only makes contact with the spring 1151, and when the force exceeds A gram-force, the pin 110 makes contact with the spring 1151 and the plurality of elastic balls 1153. The properties and positions of the spring 1151 and the plurality of elastic balls 1153 are configured to obtain a force-displacement relationship between the contact pressure and the axial displacement, as illustrated in FIG. 3C. In this example, when the force sustained by the pin 110 is increased from zero to F1, the displacement of the pin 110 correspondingly increases from zero to d1, showing a force-displacement relationship of slope 51. When the force sustained by the pin 110 is increased from F1 to F2, the displacement of the pin 110 correspondingly increases from d1 to d2, showing a force-displacement relationship of curve C1. In another embodiment, there are no gaps between the elastic balls 1153 and the horizontal walls 1051 and 1052, thus the pin 110 makes contact with the spring 1151 and the elastic balls 1153 continuously. Accordingly, the force-displacement relationship may be the curve C2, as illustrated in FIG. 3D. As a result, the present invention provides increased accuracy in detecting contact pressure, i.e., force sustained by the pin 110, as compared to conventional styluses, and thus provides a user a writing experience substantially similar to an ordinary pen.

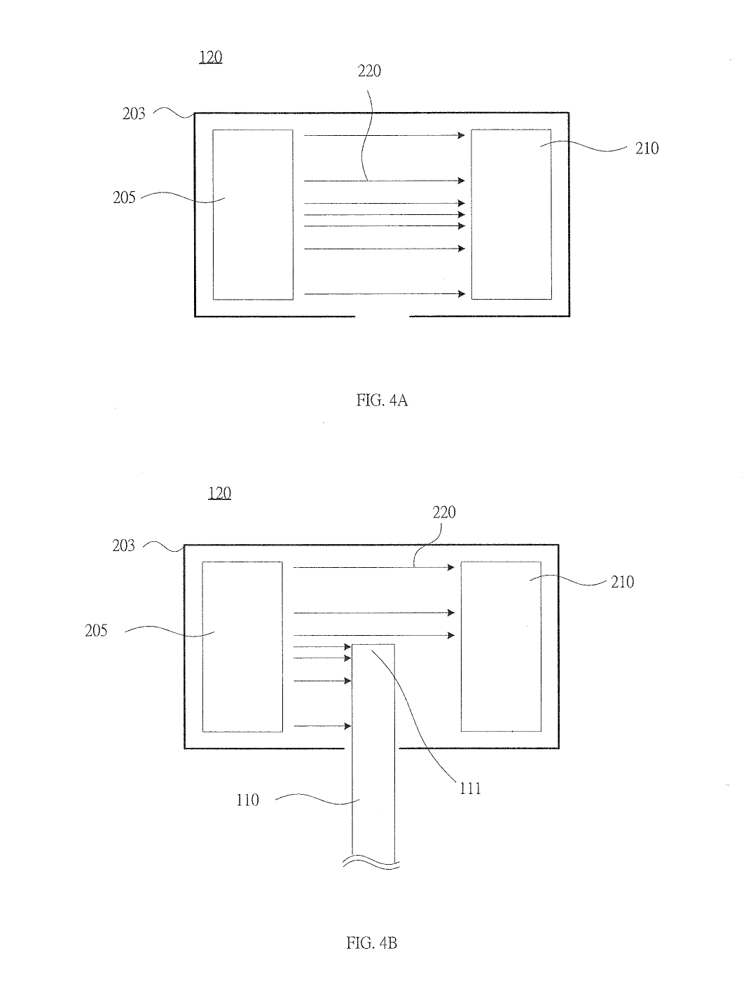

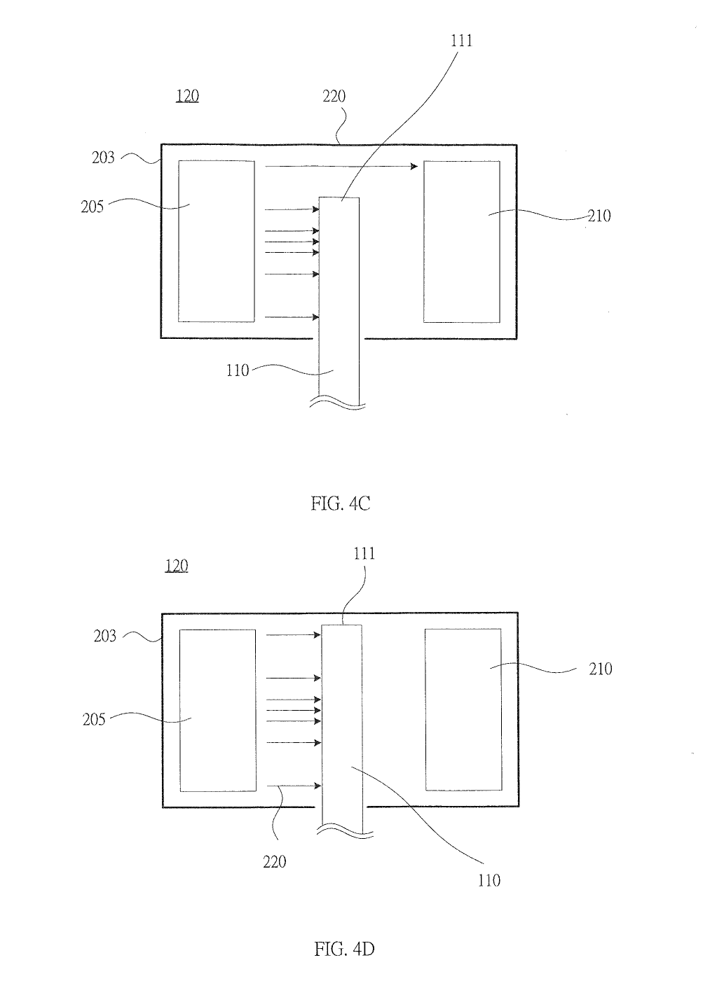

FIGS. 4A-4D are perspective views of the pressure sensor and the pin according to some embodiments of the present invention. Referring to FIG. 4A, in which the pin 110 is removed for clarity, the pressure sensor 120 comprises an emitter 205 and a detector 210. The emitter 205 emits an optical signal, e.g. light rays 220, toward a detector 210. The emitter 205 comprises a Light Emitting Diode (LED), a laser diode, a photo resistor, a PIN photodiode, or other diode. The detector 210 comprises a photodetector or any matching receiver of the aforementioned light source. The emitter 205 and detector 210 may be positioned in close proximity to each other to provide for the detector 210 to have more accurate detection of the outputting light rays 220 emitted by the emitter 205.

Referring to FIG. 4B, the pressure sensor 120 has an opening for receiving the pin 110, specifically, the first end 111. The diameter of the opening corresponds in size and shape of the first end 111 so that minimum ambient light, which interferes with the optical detection of the detector 210, is emitted into the pressure sensor 120. In the present embodiment, when the stylus 100 is not being operated by a user, i.e., in a non-contacting or non-operational state, the first end 111 may already be obstructing substantially half of the light rays 220 from being detected by the detector 210. That is, when the pin 110 is sustaining substantially zero pressure, the first end 111 is already at a position of the central of the light rays 220, as illustrated in FIG. 4B. When the pin 110 is sustaining pressure, i.e., having an axial displacement, more light rays 220 are being obstructed by the pin 110, as illustrated in FIG. 4C. Consequently, all the light rays 220 are obstructed by the pin 110 when pressure sustained by the pin 110 exceeds a predetermined value, as illustrated in FIG. 4D. Therefore, the detector 210 determines the volume of light rays 220 received and transmits such information to the communication module 130. Such information is further used to determine the pressure sustained by the pin 110. Accordingly, the present invention provides increased accuracy in detecting contact pressure as compared to conventional styluses. The increased accuracy enables the stylus 100 to determine pressure, lack of pressure and/or a change in pressure exerted on the pin 110 with only a slight axial displacement of the stylus pin 110, and thus provides a user a writing experience substantially similar to an ordinary pen.

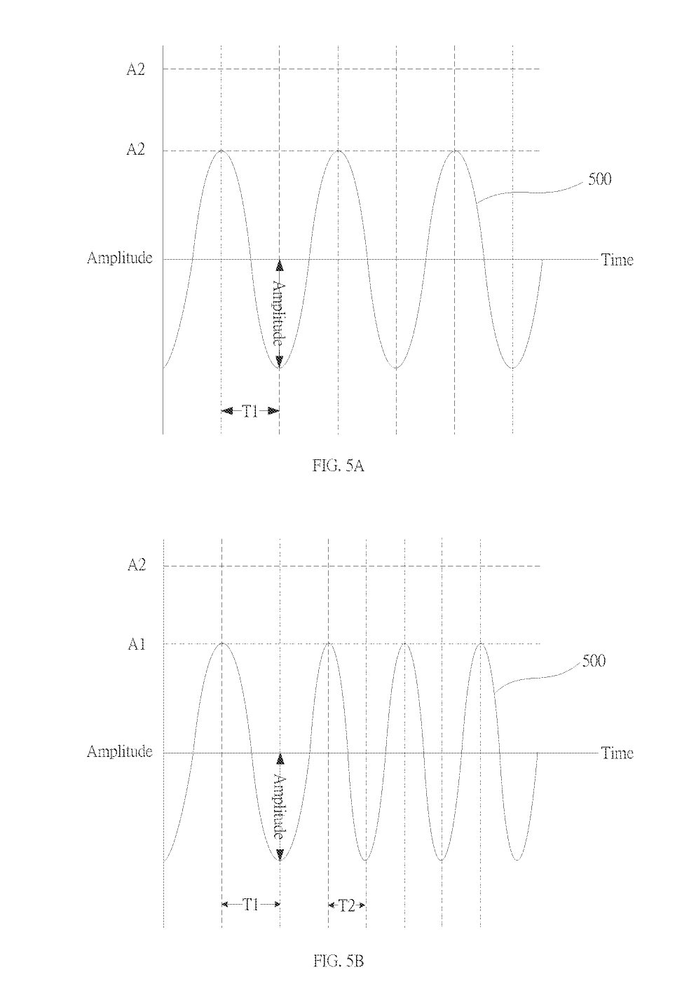

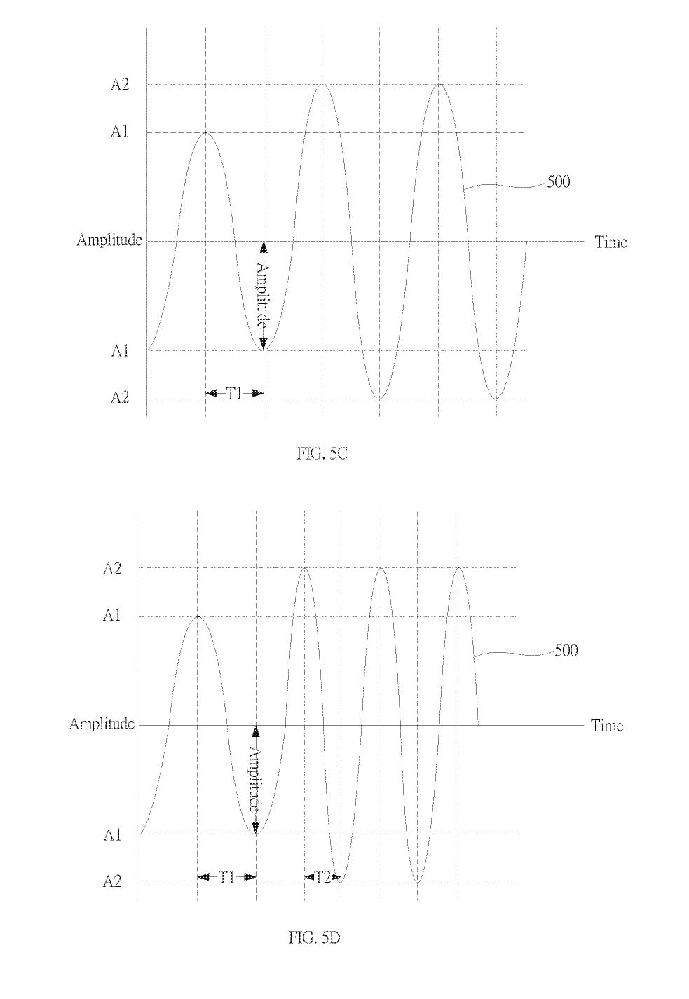

Reference is now made to FIGS. 5A-5D, showing exemplary time lines of transmission pulses transmitted by the stylus 100 in accordance with some embodiments of the present invention. In the present invention, the communication module 130 produces a pulsed oscillating signal to the receiving device 200. The communication module 130 generates and encodes signals indicative of different pressure sustained by the pin 110, i.e., the axial displacement information of the pin 110. In addition, the communication module 130 generates and encodes signals indicative of different modes by the input of a user via the one or more switches 122 on the stylus 100. The mode of the stylus 100 may include an eraser mode, mouse right-click mode or a battery health mode, but the present invention is not so limited. In some embodiments, the signal transmitted by the stylus 100 has different frequencies and amplitudes. A change in frequency and/or amplitude represents a change of mode of the stylus 100, or represents a change of pressure sustained by the pin 110.

For example, when the pin 110 is not sustaining pressure and the switch 122 is not being triggered, the waveform 500 representing the frequency and the amplitude of the signal generated and transmitted by the communication module 130 is as illustrated in FIG. 5A. When the pin 110 is sustaining pressure and the switch 122 is not being triggered, the waveform 500 is changed, as illustrated in FIG. 5B. Specifically, time T2 is shorter than time T1. That is, a waveform 500 having higher frequency represents that the pin 110 is sustaining pressure. Thus, the corresponding stroke outputted on the screen of the screen of the touch screen-equipped device should be broader. On the other hand, when the pin 110 is not sustaining pressure and the switch 122 is being triggered, the waveform 500 is changed, as illustrated in FIG. 5C. Specifically Amplitude A2 may be larger than amplitude A1. That is, a waveform 500 having higher amplitude represents that the switch 122 has been triggered. As described in the aforementioned embodiments, a trigger of the switch 122 may represent that the stylus 100 is now in an eraser mode, a mouse right-click mode or a battery health mode. In yet another embodiment, when the pin 110 is sustaining pressure and the switch is triggered simultaneously, the waveform 500 is changed, as illustrated in FIG. 5D. That is, the waveform 500 has a change in the frequency and in the amplitude at the same time. As a result different frequencies and/or different amplitudes are applied to the present invention to represent different pressure sustained and/or different mode triggered.

Accordingly, the present invention provides a stylus with pressure sensor in the form of an optical sensor for the stylus to detect a pressure and/or a change in pressure exerted on its tip. The pressure sensor comprises a light emitter and a light detector for improving accuracy in detecting contact pressure sustained by the stylus tip. The pressure sensor responds to a luminance change which decreases along with an increment of the displacement of the stylus pin and accordingly generates electric signals representing such increment of displacement. In another embodiment, the present invention provides a communication module transmitting different types of signals corresponding to modes of operation of the stylus triggered by a user. Specifically, a change in the amplitude and/or wavelength of the signal represents and implements different modes of operation of the stylus so as to provide more than the ordinary controlling function.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A pressure-sensitive stylus, comprising: a tip operationally coupled to a pressure sensor, the tip constrained to depress longitudinally, the tip mechanically coupled to a first spring, the tip engaging a second spring when depressed longitudinally by a force of a first magnitude.
